(19) United States
(12) Patent Application Publication
(10) Pub. No.: US 2023/0078618 A1
(43) Pub. Date: Mar. 16, 2023

(54) FILTERING SYSTEM, IN PARTICULAR FOR A WASHING OR DRYING MACHINE, SUCH AS A LAUNDRY WASHING MACHINE OR A CLOTHES DRYER

(71) Applicant: ELBI INTERNATIONAL S.P.A., Torino (IT)

(72) Inventors: Marco BECCHIO, Carignano (TO) (IT); Gabriele BELLATO, Torino (IT); Mauro MARANGON, Torino (IT); Alessandro POMPA, Rivoli (TO) (IT); Paolo RAVEDATI, Moncalieri (TO) (IT); Gianluca BENEDETTO, Torino (IT)

(73) Assignee: ELBI INTERNATIONAL S.P.A., Torino (IT)

(21) Appl. No.: 17/942,671

(22) Filed: Sep. 12, 2022

(30) Foreign Application Priority Data
Sep. 13, 2021 (IT) 102021000023561

(51) Int. Cl. B01D 29/64; B01D 29/11; B01D 29/94; B01D 35/147; B01D 35/153; B01D 35/143; B01D 29/60

(52) U.S. Cl. CPC B01D 29/6476; B01D 29/117; B01D 29/94; B01D 35/147; B01D 35/153; B01D 35/143; B01D 29/606

(57) ABSTRACT

A filtering system (10) includes a casing (12) internally defining a cavity (14) and has an inlet (16) configured to receive a fluid and leading into the cavity (14), and an outlet (18) configured to deliver the fluid coming from the cavity (14). A filtering assembly (100) is contained in the cavity (14) and is configured to be crossed by the fluid entering the casing (12) through the inlet (16), so as to trap any solid particles, in particular microplastic ones, contained in the fluid. A compacting assembly (200) situated in the cavity (14) is configured for collecting and compacting the solid particles trapped by the filtering assembly (100). A driving assembly (300) is configured to drive the compacting assembly (200).

### TECHNICAL FIELD

The present invention relates to a filtering system, in particular for a washing or drying machine, such as a laundry washing machine or a clothes dryer.

### TECHNICAL BACKGROUND

Filtering systems for washing or drying machines are known in the art. However, such types of filtering systems suffer from a number of drawbacks that should be remedied.

### SUMMARY OF THE INVENTION

It is one object of the present invention to provide a filtering system capable of overcoming the drawbacks of the prior art while at the same time being simple and economical to manufacture.

According to the present invention, this and other objects are achieved through a filtering system having the technical features set out in the appended independent claim.

It is understood that the appended claims are an integral part of the technical teachings provided in the following detailed description of the present invention. In particular, the appended dependent claims define some preferred embodiments of the present invention that include some optional technical features.

Further features and advantages of the present invention will become apparent in light of the following detailed description, provided herein merely as a non-limiting example and referring, in particular, to the annexed drawings as summarized below.

### BRIEF DESCRIPTION OF THE DRAWINGS

FIGS. 1 and 2 are perspective views from above and, respectively, from below of a filtering system made in accordance with an exemplary embodiment of the present invention.

FIG. 3 is an exploded perspective view of the system shown in the preceding Figures.

FIG. 4 is a block diagram representing the system shown in the preceding Figures from a functional viewpoint.

FIGS. 5 to 9 are longitudinal sectional views of the system shown in the preceding Figures, wherein such system is illustrated in different operating conditions.

For completeness' sake, the following is a list of alphanumerical references and names used herein to identify parts, elements and components illustrated in the above-summarized drawings.
WM. Laundry washing machine
X-X. Longitudinal axis
S1. Position sensor
S2. Clogging sensor
S3. Filling sensor
10. Filtering system
12. Casing
14. Cavity
14a. Central chamber
14b. Upper chamber
14c. Annular chamber
16. Inlet
18. Outlets
20. Storing container
22. Hollow portion
24. Upper closure member
26. Lower closure member
28. Upper sealing gasket
30. Lower sealing gasket
32. Sealing element
34. Support pin
36. Compression spring
38. Compression spring
40. Filter
100. Filtering assembly
102. Hollow body
104. Axial through aperture
200. Compacting assembly
202. Endless screw
204. Helicoidal profile
300. Driving assembly
302. Electric motor
303. Reduction gear train
304. Shaft
304a. First section
304b. Second section
400. Flow diverter assembly
402. Diaphragms
402a. First diaphragm
402b. Second diaphragm
402c. Third diaphragm
500. Bypass assembly
502. Non-return valve

### DETAILED DESCRIPTION OF THE INVENTION

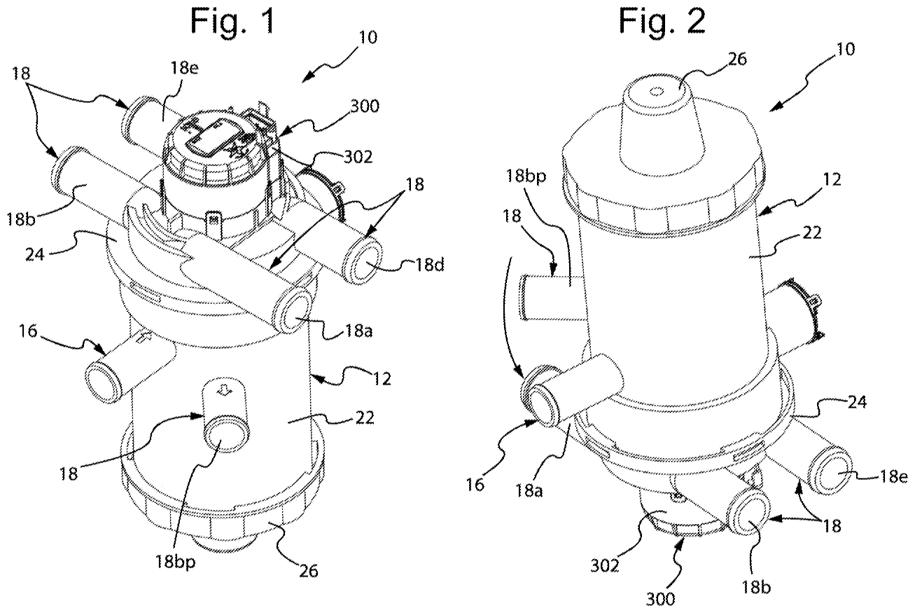

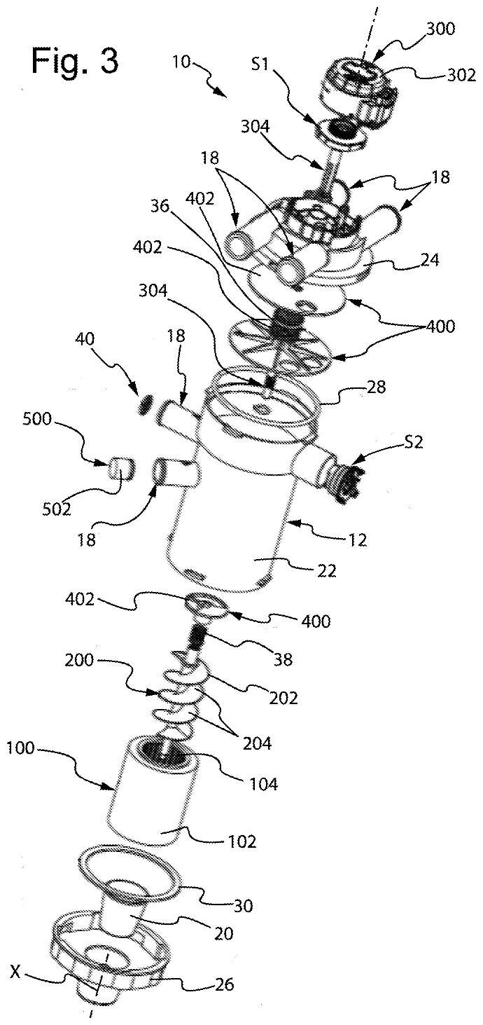

With reference to the annexed drawings, and in particular to FIGS. 1 to 3, numeral 10 designates as a whole a filtering system according to an exemplary embodiment of the present invention. System 10 is applicable, in particular, to a washing or drying machine, such as a laundry washing machine or a clothes dryer. In the embodiment illustrated herein, system 10 will be described with particular reference to a laundry washing machine WM.

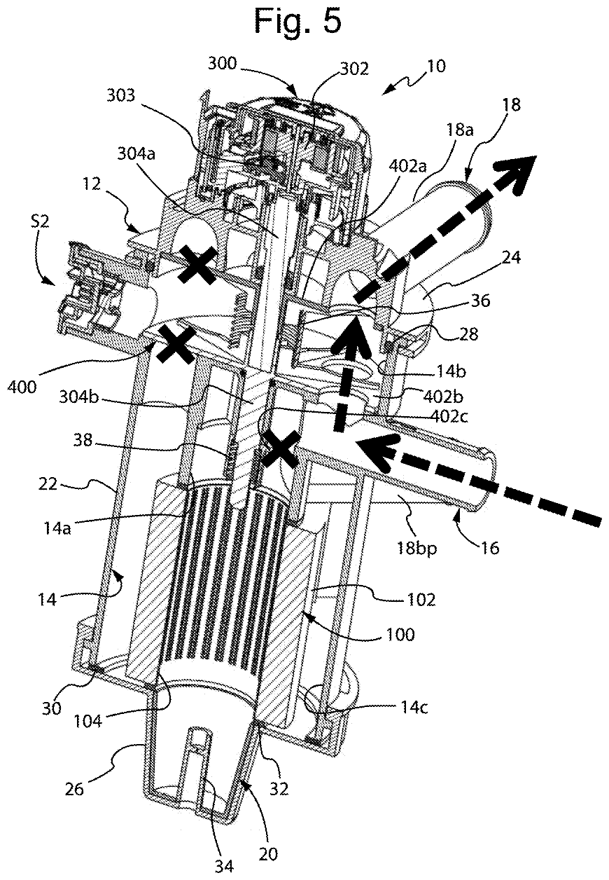

System 10 comprises a casing 12 internally defining a cavity 14 (as indicated in FIGS. 5 to 9) and comprising an inlet 16 configured to receive a fluid. Inlet 16 leads into cavity 14.

In the illustrated embodiment, casing 12 comprises a plurality of outlets (in particular, as will be described more in detail below, it includes five outlets), designated as a whole as 18 and configured for delivering the fluid coming from cavity 14. Nevertheless, in further alternative embodiments (not shown) the casing may comprise fewer outlets, even only one.

System 10 further comprises a filtering assembly 100 contained in cavity 14. Filtering assembly 100 is configured to be crossed by a fluid entering casing 12 through inlet 16, so as to trap any solid particles, in particular microplastic ones, contained in said fluid.

System 10 comprises also a compacting assembly 200 situated in cavity 14 and configured for collecting and compacting the solid particles trapped by filtering assembly 100.

In addition, system 10 comprises a driving assembly 300 configured to drive compacting assembly 200. Preferably, driving assembly 300 comprises a motor, in particular an electric motor 302. In the illustrated embodiment, electric motor 302 co-operates with a reduction gear train 303 to drive compacting assembly 200. The action of compacting assembly 200 makes it possible to keep filtering assembly 100 cleaner, thereby extending its service life.

Preferably, filtering assembly 100 comprises a hollow body 102 having an axial through aperture 104. More preferably, as will be described hereinafter, axial through aperture 104 is crossed by compacting assembly 200. In the illustrated embodiment, hollow body 102 has a substantially cylindrical shape, internally defining axial through aperture 104.

As will be described in more detail below, hollow body 102 advantageously comprises a plurality of concentrical filtering layers of different mesh gauges, suitable for trapping microplastic particles of different sizes.

Furthermore, filtering assembly 100 is preferably mounted in casing 12 in a removable manner.

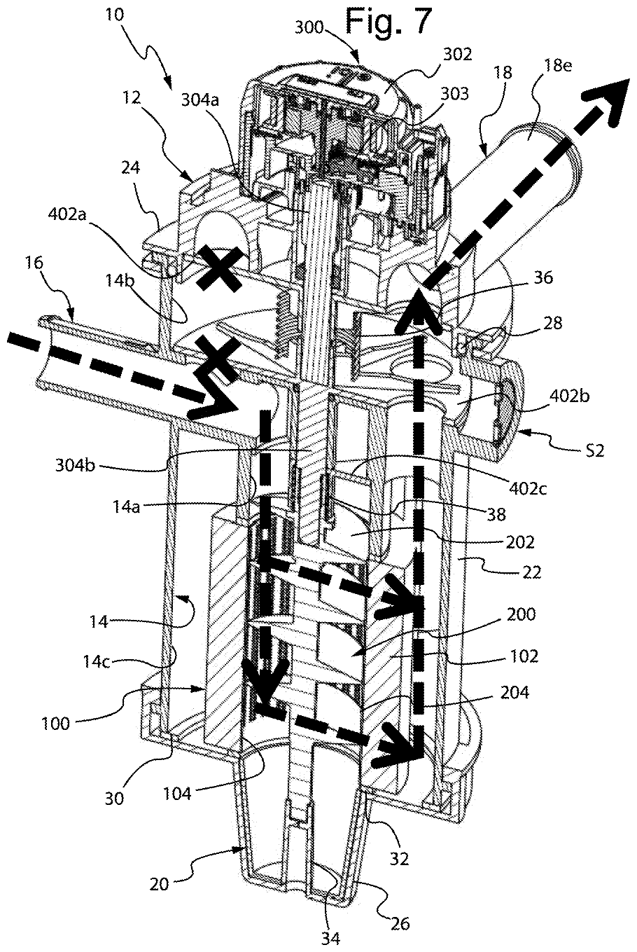

In the embodiment illustrated herein, compacting assembly 200 is configured to remove solid particles from the surface of filtering assembly 100 configured to fluidically communicate with inlet 16, in particular by conveying them towards the bottom or out of filtering assembly 100. In other words, as clearly shown in the drawings (e.g. in FIGS. 7 to 9), and as can be directly and unambiguously deduced therefrom, compacting assembly 200 is operatively mounted in contact with said surface of filtering assembly 100 in order to remove said solid particles from the latter. Thus, compacting assembly 200 is configured to operatively slide against said surface of filtering assembly 100, thereby removing any solid particles from said surface.

Preferably, compacting assembly 200 extends axially through filtering assembly 100.

In the illustrated embodiment, compacting assembly 200 comprises an endless screw 202 configured to be rotatably driven by driving assembly 300, so as to axially push the solid particles trapped by filtering assembly 100.

In particular, endless screw 202 has a helicoidal profile 204 that, in a per se known manner, facilitates the conveyance of the particles out of filtering assembly 100. In other words, as clearly visible in the drawings (e.g. in FIGS. 7 to 9), and as can be directly and unambiguously deduced therefrom, helicoidal profile 204 is operatively mounted in contact with the surface of filtering assembly 100 configured to fluidically communicate with inlet 16. In this way, helicoidal profile 204—rotatably driven by driving assembly 300—can effectively remove the solid particles deposited on said surface of the filtering assembly 100. In fact, helicoidal profile 204 is configured to rotatably slide against said surface of filtering assembly 100, thereby removing any solid particles therefrom.

Preferably, system 10 further comprises a storing container 20 situated in cavity 14 and facing compacting assembly 200. Storing container 20 is configured to receive the solid particles collected and compacted by compacting assembly 200. Particularly, storing container 20 is removably mounted in cavity 14 and is accessible through casing 12.

In the embodiment illustrated herein, as aforementioned, plurality of outlets 18 include a first outlet 18a, a second outlet 18b, a third outlet 18d, a fourth outlet 18e and, preferably, also a bypass outlet 18bp. Each one of outlets 18a, 18b, 18d, 18e and 18bp is configured for delivering the fluid coming from cavity 14. Moreover, the system comprises a flow diverter assembly 400 situated in cavity 14 and configured for assuming a plurality of operating conditions defining, through cavity 14, a respective plurality of fluid paths between inlet 16 and the plurality of outlets 18. By way of example, each one of such operating conditions is shown in each one of FIGS. 5 to 9 through cavity 14 and defines a respective fluid path between inlet 16 and one of outlets 18a, 18b, 18d, 18e and 18bp.

As will be further described below with reference to the exemplary embodiment illustrated in the drawings, and particularly with reference to FIGS. 7, 8 and 9, at least one of said operating conditions provides a fluid path that goes through filtering assembly 100.

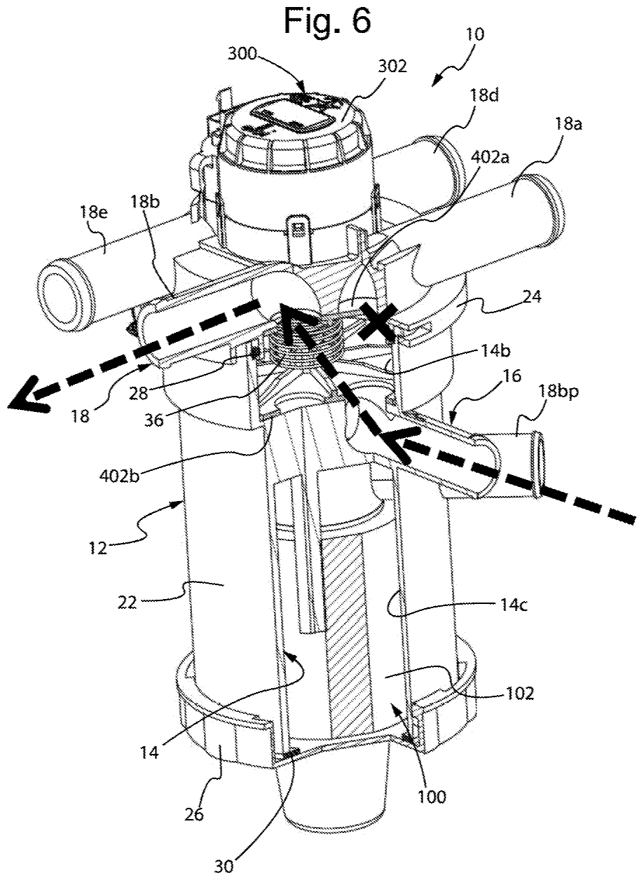

Still with reference to the exemplary embodiment illustrated in the drawings, and particularly with reference to FIGS. 5 and 6, at least another one of the operating conditions provides a further fluid path that does not go through filtering assembly 100.

Preferably, driving assembly 300 is configured for controlling also the flow diverter assembly 400, switching it between said operating conditions.

In particular, flow diverter assembly 400 axially faces filtering assembly 100.

In the illustrated embodiment, flow diverter assembly 400 comprises a plurality of diaphragms 402 having holes (not numbered) and mutually co-operating to define the fluid paths between inlet 16 and outlets 18 through such holes. The plurality of diaphragms 402 can rotate into different relative angular positions defined by driving assembly 300, in particular by electric motor 302, possibly co-operating with reduction gear train 303. In each one of such relative angular positions, the holes of the plurality of diaphragms 402 are either mutually aligned or offset in such a way as to define a respective fluid path between inlet 16 and the plurality of outlets 18.

In particular, flow diverter 400 comprises a first diaphragm 402a, a second diaphragm 402b and a third diaphragm 402c axially aligned with one another and configured to be rotatably driven, in a coordinated manner, around the same axis of rotation. In some alternative and simpler embodiments of the present invention, the flow diverter assembly may include only a couple of diaphragms or even just one diaphragm configured to be rotatably driven.

Preferably, system 10 further comprises a bypass assembly 500 configured for automatically excluding filtering assembly 100 from the fluid flow from inlet 16 to one of the plurality of outlets 18 in predetermined operating conditions.

Preferably, bypass assembly 500 comprises a non-return valve 502 mounted upstream of filtering assembly 100.

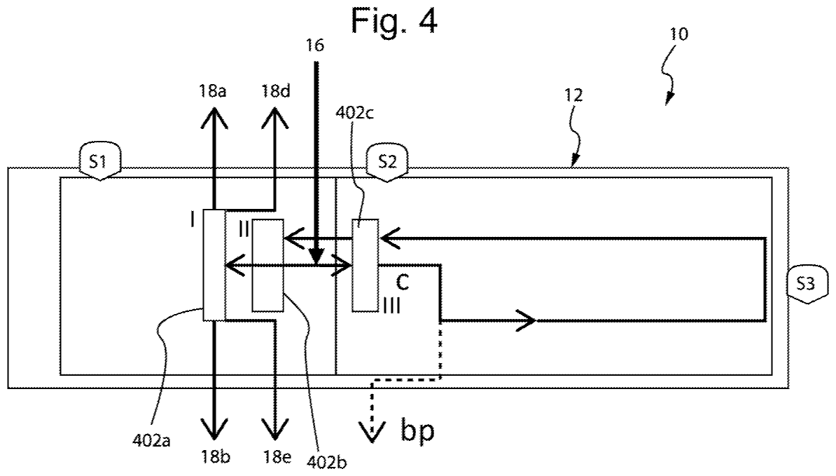

In the embodiment illustrated herein, with particular reference to FIG. 4, system 10 comprises a position sensor S1 configured to detect the angular position taken by the plurality of diaphragms 402 and corresponding to a respective operating condition assumed by flow diverter assembly 400. For example, position sensor S1 may be an encoder or an electric commutator actuated by cam profiles carried by driving assembly 300 and/or by flow diverter assembly 400.

Preferably, system 10 comprises a clogging sensor S2 configured to detect a clogging of filtering assembly 100. For example, clogging sensor S2 is a pressure sensor situated upstream and/or downstream of filtering assembly 100.

Particularly, system 10 comprises a filling sensor S3 configured to detect when storing container 20 is full. For example, the filling sensor may be a switch (a mechanical or reed switch) or an inductive magnetic sensor (e.g. a magnetoresistor or a Hall-effect sensor) configured to switch when compacting assembly 200 is continuing to push filtered particles towards storing container 20 while the latter is already full; in other words, when storing container 20 is full and can no longer store other material removed from filtering assembly 100 by compacting assembly 200, a movement is generated which is detected by filling sensor S3.

The following will describe some further preferable and optional technical details of the embodiment of the present invention illustrated herein.

Casing 12 comprises a hollow portion 22 and a pair of closure members 24 and 26 sealingly connected on opposite sides of hollow portion 22, defining therein cavity 14. In particular, there are an upper closure member 24 and a lower closure member 26. Moreover, hollow portion 22 has a substantially tubular shape and extends along a longitudinal axis X-X.

Fluid tightness of casing 12 is obtained by means of a pair of sealing gaskets 28 and 30 interposed between closure members 24 and 26 and hollow portion 22. Upper sealing gasket 28 is peripherally adjacent to upper closure member 24 on one side and to the top of hollow portion 22 on the other side. Lower sealing gasket 30 is axially adjacent to lower closure member 26 on one side and to the top of hollow portion 22 on the other side. In particular, sealing gaskets 28, 30 have a substantially annular shape, e.g. they are O-rings.

Inlet 16 is formed laterally on casing 12. Preferably, inlet 16 is formed laterally, in particular radially, on hollow portion 22.

The plurality of outlets 18 are formed laterally on casing 12. Preferably, outlets 18a, 18b, 18d, 18e are formed laterally on upper closure member 26, whereas outlet 18bp is formed laterally, in particular radially, on hollow portion 22.

Storing container 20 has a substantially cup-like shape and is housed in lower closure member 26. Furthermore, axial through aperture 104 of hollow body 102 faces towards storing container 20. Between hollow body 102 and storing container 20 a sealing element 32, e.g. an O-ring, is axially adjacent.

Lower closure member 26 is removably, in particular repeatably and reversibly, mounted to hollow portion 22. For example, lower closure member 26 can be coupled to and decoupled from, respectively, hollow portion 22, so that a user can gain access to the inside of casing 12. Particularly, a bayonet mechanism or a threaded connection may be provided for removably coupling lower closure member 26 to hollow portion 22. It is therefore possible to remove storing container 20 from casing 12 in order to empty it of the solid particles accumulated therein and compacted by compacting assembly 200.

Driving assembly 300 comprises a shaft 304 configured to be rotatably driven by electric motor 302, in particular via reduction gear train 303, for controlling compacting assembly 200. In particular, shaft 304 extends in cavity 14 through upper closure member 24 in order to co-operate with compacting assembly 200. In the illustrated embodiment, shaft 304 is coupled to endless screw 202 to control the rotation thereof, such two parts being in particular rotatably integral (e.g. keyed) with each other. In more detail, shaft 304 and endless screw 202 are substantially coaxial to each other and to longitudinal axis X-X.

In particular, position sensor S2 is configured to detect the angular position taken by shaft 304, being equipped with electric switching means (not numbered) and a cam profile (not numbered) mounted to the shaft 304 and integrally rotatable therewith to co-operate with such electric switching means.

Moreover, endless screw 202 is housed in axial through cavity 104 of hollow body 102 and is substantially aligned axially with longitudinal axis X-X. In more detail, endless screw 202 is rotatably supported in cavity 14 of casing 12 by the coupling of one end thereof with shaft 304 on one side and, on the other side, by the insertion of its opposite end into a support pin 34 protruding from the bottom of lower closure member 26 and going through storing container 20.

As is clearly visible in the drawings (e.g. in FIGS. 7 to 9), and as can be directly and unambiguously deduced therefrom, the outer lateral surface of helicoidal profile 204 is operatively situated in contact with the inner lateral surface of filtering assembly 100. Thus, when driving assembly 300 is activated, the outer lateral surface of helicoidal surface 204 will rotatably slide against the inner lateral surface of filtering assembly 100, thereby removing the solid particles deposited on filtering assembly 100.

The plurality of diaphragms 402 are rotatably driven by shaft 304, in particular around longitudinal axis X-X. In the illustrated embodiment, the plurality of diaphragms 402 are carried by shaft 304. Moreover, shaft 304 comprises a first section 304a and a second section 304b axially connected to each other. The first section 304a has the first diaphragm 402a keyed onto it, whereas the second diaphragm 402b is made as one piece with the second section 304b and the third diaphragm 402c is keyed onto the second section 304b.

The first diaphragm 402a and the second diaphragm 402b are axially spaced apart by a compression spring 36 mounted around the first section 304a and the second section 304b. Likewise, the second diaphragm 402b and the endless screw 202 are axially spaced apart by another compression spring 38 mounted around the second section 304b. In this way, springs 36 and 38 contribute to improving the sealing along the fluid path defined by the plurality of diaphragms 402.

In the embodiment illustrated herein, inlet 16 is equipped with a filter 40, e.g. configured to prevent any particles that are bigger than microplastic ones (e.g. large filaments, coins or buttons) from crossing it.

The following will describe, with reference to the embodiment illustrated herein by way of example, some examples of the operating conditions that diverter assembly 400 can assume when system 10 is in operation.

In FIG. 5, diverter assembly 400 is putting inlet 16 in fluidic communication with the first outlet 18a, excluding filtering assembly 100 from the fluid path.

In particular, inlet 16 is configured to communicate, in a substantially axial direction (i.e. in a direction that is substantially parallel to the longitudinal axis X-X), with a central chamber 14a on one side, and to communicate, in a substantially axial direction, with an upper chamber 14b on the other side. Central chamber 14a communicates axially with filtering assembly 100, while upper chamber 14b is configured to communicate, in a substantially axial direction, with the plurality of outlets 18. As clearly shown, chambers 14a and 14b are defined by inner walls of casing 12.

The third diaphragm 402c is configured to selectively allow or prevent the flow of fluid from inlet 16 to central chamber 14a. The second diaphragm 402b is configured to selectively allow or prevent the flow of fluid from inlet 16 to upper chamber 14b. The first diaphragm 402a is configured to selectively allow or prevent the flow of fluid from upper chamber 14b to one or more of outlets 18a, 18b, 18d and 18e.

In the operating condition shown in FIG. 5, therefore, the third diaphragm 402c prevents the fluid from flowing from inlet 16 to central chamber 14a, thus excluding filtering assembly 100 from the fluid path. Conversely, the second diaphragm 402b allows the fluid to flow from inlet 16 to upper chamber 14b. Lastly, the first diaphragm 14a selectively allows the fluid to flow from upper chamber 14b to the first outlet 18a only.

In FIG. 6, diverter assembly 400 is putting inlet 16 in fluidic communication with the second outlet 18b, excluding filtering assembly 100 from the fluid path.

In the operating condition shown in FIG. 6, therefore, the third diaphragm 402c prevents the fluid from flowing from inlet 16 to central chamber 14a, thus excluding filtering assembly 100 from the fluid path. Conversely, the second diaphragm 402b allows the fluid to flow from inlet 16 to upper chamber 14b. Lastly, the first diaphragm 14a selectively allows the fluid to flow from upper chamber 14b to the second outlet 18b only.

In FIG. 7, diverter assembly 400 is putting inlet 16 in fluidic communication with the fourth outlet 18e, including filtering assembly 100 in the fluid path.

In particular, central chamber 14a is configured to communicate, in a substantially radial direction (i.e. a direction substantially perpendicular to the longitudinal axis X-X), with an annular chamber 14c through filtering assembly 100. Furthermore, annular chamber 14c is configured to communicate, in a substantially axial direction, with upper chamber 14b. As clearly shown, annular chamber 14c is defined by inner walls of casing 12.

The second diaphragm 402b is also configured to selectively allow or prevent the flow of fluid from annular chamber 14c to upper chamber 14b.

In the operating condition shown in FIG. 7, therefore, the third diaphragm 402c allows the fluid to flow from inlet 16 to central chamber 14a, so that the fluid will flow radially outwards through filtering assembly 100 and reach annular chamber 14c. Moreover, the second diaphragm 402b prevents the fluid from flowing from the inlet 16 to upper chamber 14b, while however allowing the fluid to flow from annular chamber 14c to upper chamber 14b. Lastly, the first diaphragm 14a selectively allows the fluid to flow from upper chamber 14b to the fourth outlet 18e only.

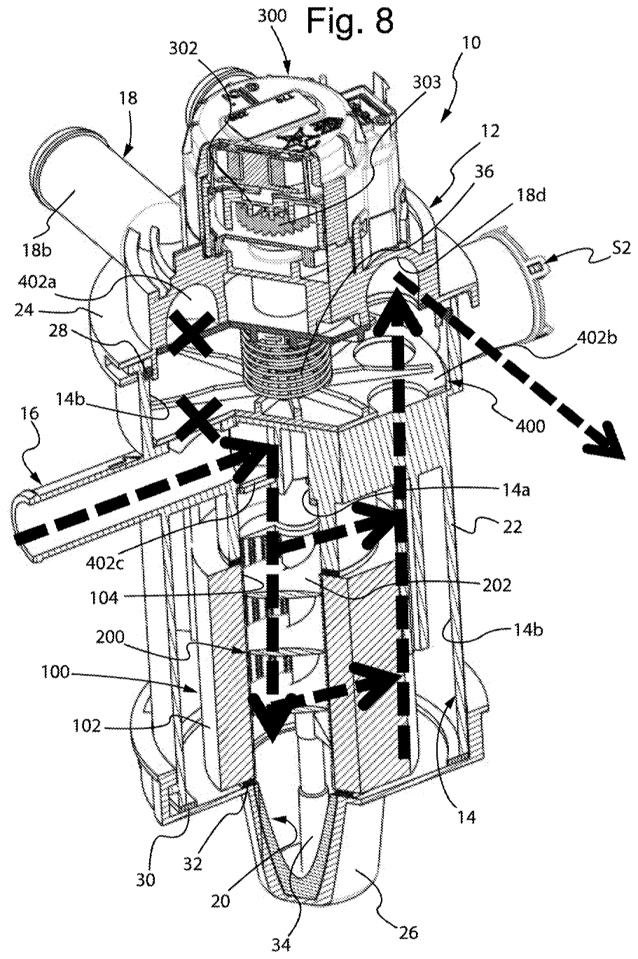

In FIG. 8, diverter assembly 400 is putting inlet 16 in fluidic communication with the third outlet 18d, including filtering assembly 100 in the fluid path.

In the operating condition shown in FIG. 8, therefore, the third diaphragm 402c allows the fluid to flow from inlet 16 to central chamber 14a, so that the fluid will flow radially outwards through filtering assembly 100 and reach annular chamber 14c. Moreover, the second diaphragm 402b prevents the fluid from flowing from inlet 16 to upper chamber 14b, while however allowing the fluid to flow from annular chamber 14c to upper chamber 14b. Lastly, the first diaphragm 14a selectively allows the fluid to flow from upper chamber 14b to the third outlet 18d only.

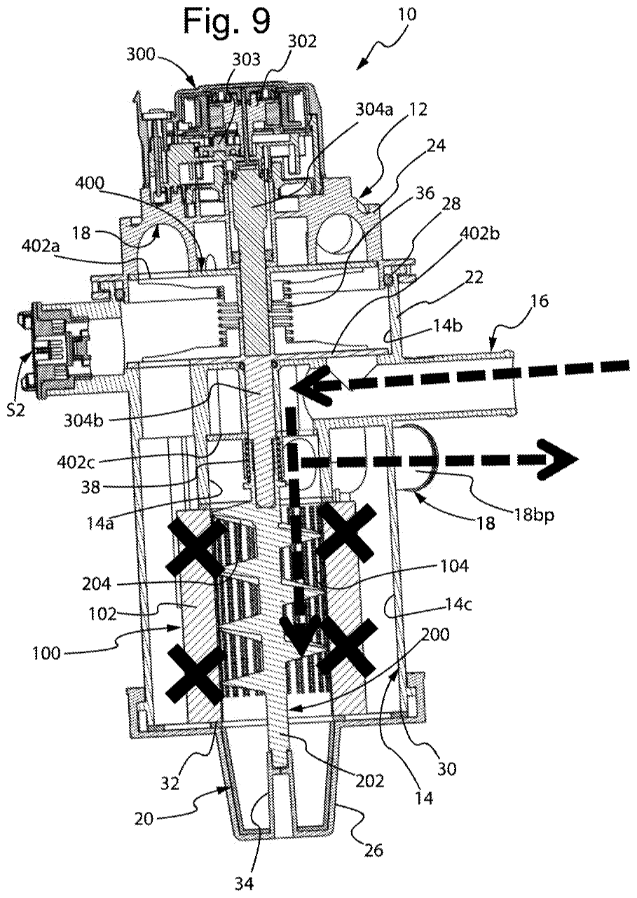

In FIG. 9, diverter assembly 400 is putting inlet 16 in fluidic communication with bypass outlet 18bp, including filtering assembly 100 in the fluid path.

In particular, central chamber 14a is configured to communicate in a substantially radial direction with bypass outlet 18bp.

Furthermore, non-return valve 502 is connected between central chamber 14a and bypass outlet 18bp to allow the fluid to flow between them when the pressure in central chamber 14a exceeds a predetermined threshold value, which particularly corresponds to a clogged condition of filtering assembly 100.

In the operating condition shown in FIG. 9, therefore, the third diaphragm 402c allows the fluid to flow from inlet 16 to central chamber 14a. If filtering assembly 100 is clogged, however, the fluid will not be able to reach annular chamber 14c. This will translate into an abnormal increase of the pressure in central chamber 14a, such as to cause non-return valve 502 to open, resulting in the fluid exiting through bypass outlet 18bp.

Of course, without prejudice to the principle of the invention, the forms of embodiment and the implementation details may be extensively varied from those described and illustrated herein by way of non-limiting example, without however departing from the scope of the invention as set out in the appended claims.

System 10 can be installed on a duct leading into the wash tub of laundry washing machine WM, or on the drawer of the latter. Thus, the water dripping from system 10 when filtering assembly 100 is replaced or the compacted residue is removed (e.g. from storing container 20) will return into the tub without dripping onto the floor outside laundry washing machine WM. Furthermore, system 10 can be installed with a suitable angle to allow the water stagnating in system 10 to flow towards one of outlets 18 (preferably one of those leading into the wash tub), thereby limiting as much as possible any dripping when replacing filtering assembly 100 or removing the compacted residue (e.g. from storing container 20).

1. A filtering system for a washing or drying machine, said system comprising:
a casing internally defining a cavity and comprising an inlet configured to receive a fluid and leading into the cavity, and at least one outlet configured to deliver the fluid coming from the cavity;
a filtering assembly contained in the cavity and configured to be crossed by the fluid entering said casing through the inlet, so as to trap any solid microplastic particles contained in said fluid;
a compacting assembly situated in said cavity and configured for collecting and compacting the solid particles trapped by the filtering assembly; and
a driving assembly configured to drive the compacting assembly.

2. The system according to claim 1, wherein the compacting assembly is configured to remove the solid particles from a surface of the filtering assembly configured to fluidically communicate with said inlet by conveying the particles towards a bottom or out of said filtering assembly.

3. The system according to claim 1, wherein said compacting assembly extends axially through the filtering assembly.

4. The system according to claim 1, wherein said compacting assembly comprises an endless screw configured to be rotatably driven by the driving assembly, so as to axially push the solid particles trapped by the filtering assembly.

5. The system according to claim 1, further comprising a storing container situated in the cavity, which faces the compacting assembly and is configured to receive the solid particles collected and compacted by said compacting assembly.

6. The system according to claim 5, wherein the storing container is removably mounted in the cavity and is accessible through the casing.

7. The system according to claim 1, wherein the filtering assembly comprises a hollow body having an axial through aperture crossed by said compacting assembly.

8. The system according to claim 7, wherein said hollow body has a substantially cylindrical shape internally defining said axial through aperture.

9. The system according to claim 5, wherein said hollow body has a substantially cylindrical shape internally defining said axial through aperture, and wherein said axial through aperture faces towards said storing container.

10. The system according to claim 1, wherein said casing comprises a plurality of outlets configured for delivering the fluid coming from the cavity; said system further comprising a flow diverter assembly situated in the cavity and configured for assuming a plurality of operating conditions defining, through the cavity, a respective plurality of fluid paths between the inlet and the outlets.

11. The system according to claim 10, wherein at least one of said operating conditions provides a fluid path that goes through said filtering assembly.

12. The system according to claim 10, wherein at least one of said operating conditions provides an additional fluid path that does not go through said filtering assembly.

13. The system according to claim 10, wherein said driving assembly is configured for controlling said flow diverter assembly, switching said flow diverter assembly between said operating conditions.

14. The system according to claim 10, wherein said flow diverter assembly axially faces the filtering assembly.

15. The system according to claim 10, wherein said flow diverter assembly comprises at least one diaphragm having at least one hole and configured to be rotatably driven.

16. The system according to claim 15, wherein said flow diverter assembly comprises a plurality of perforated diaphragms axially aligned with one another and configured to be rotatably driven in a coordinated manner around the same axis of rotation.

17. The system according to claim 1, further comprising a bypass assembly configured for automatically excluding the filtering assembly from the fluid flow from the inlet to said at least one outlet in predetermined operating conditions.

18. The system according to claim 17, wherein said bypass assembly comprises a non-return valve mounted upstream of the filtering assembly.

19. The system according to claim 1, further comprising a clogging sensor configured to detect clogging of the filtering assembly.

20. The system according to claim 19, wherein said clogging sensor comprises a pressure sensor situated upstream and/or downstream of the filtering assembly.
